(19) United States
(12) Patent Application Publication
(10) Pub. No.: US 2025/0306891 A1
(43) Pub. Date: Oct. 2, 2025

(54) AUTOMATED DETECTION AND NOTIFICATION OF PACKAGE CHANGES FOR SOFTWARE UPDATES IN A COMPUTER ENVIRONMENT

(71) Applicant: Red Hat, Inc., Raleigh, NC (US)

(72) Inventors: Marek Filip, Brno (CZ); Tomas Meszaros, Brno (CZ)

(21) Appl. No.: 18/623,231

(22) Filed: Apr. 1, 2024

(51) Int. Cl. G06F 8/65; G06F 21/57

(52) U.S. Cl. CPC G06F 8/65; G06F 21/577; G06F 2221/033

(57) ABSTRACT

In one example, a method can detect and notify a user of package breaking changes for software in a computer environment. The method includes receiving, from a user, a request associated with upgrading a software program of a computing device from a first version to a second version of the software program, where the second version is newer than the first version. The method may then determine a package difference between the second version and a third version of the software program, with the third version of the software program being newer than the second version. The package difference may be a change to a package associated with the software program. The method then may output a notification indicating the package difference prior to the computing device being upgraded from the first version to the second version.

### TECHNICAL FIELD

The present disclosure relates generally to software updates. More specifically, but not by way of limitation, this disclosure relates to automatically determining package differences between software programs and outputting notifications indicating the package differences.

### BACKGROUND

A user of a computing system may have several versions of a software program available to them. Each individual version of the software program may include a large number of software packages. There can be package differences between two software versions of the software program. For example, packages may be replaced, removed, updated, split, or otherwise modified between different versions of the software program.

### BRIEF DESCRIPTION OF THE DRAWINGS

FIG. 1 is a block diagram of an example of a system with an analyzer for automatically detecting package differences according to some aspects of the present disclosure.

FIG. 2 is a block diagram of a package evolution database according to some aspects of the present disclosure.

FIG. 3 is a block diagram of an example of a system with an analyzer for automatically detecting package differences according to some aspects of the present disclosure.

FIG. 4 is a flow chart of an example of a process for automatically detecting package differences according to some aspects of the present disclosure.

FIG. 5 is a flow chart of an example of a process for detecting an incompatibility between a package change and a hardware component according to some aspects of the present disclosure.

FIG. 6 is a flow chart of an example of a process for detecting a vulnerability in a software program according to some aspects of the present disclosure.

### DETAILED DESCRIPTION

A user may wish to upgrade a computer system from a current version of a software program to a newer version of the software program. When upgrading from the current version to the newer version, the user may not know the downstream effects of the upgrade. For example, the newer version of the software program may raise security vulnerabilities or other problems if the newer version deletes, renames, splits, replaces, or in any other way changes a package. This problem can become even more complex when there are three or more versions of the same software program, where a later version of the software program deprecates or otherwise modifies a package in an earlier version. For example, a user upgrading from the first version to the second version may not realize that a package in the second version was later modified or deprecated in the third version, which may be problematic for the user. If the user had this information beforehand, the user may have chosen not to upgrade from the first version to the second version of the software program. But without this information, the user may not realize the problem until it is too late.

Some examples of the present disclosure can overcome one or more of the abovementioned problems by automatically detecting package changes and risks when upgrading a software program, thereby allowing a user to know in advance how software performance will be affected. As an example, an analyzer can receive, from a user, a request to upgrade a software program in the computing device from a first version to a second version. As used herein, ordinal terms such as “first”, “second”, “third”, etc. in the claims or description are not intended to connote any priority, precedence, or order of elements. Rather, the ordinal terms are used merely as labels to distinguish one element having a certain name from another element having the same name (but for use of the ordinal term). Thus, the second version can be any version of the software program that is newer than the first version, and may not be literally v2.0 of the software program. In response to receiving the request, the analyzer may then determine differences in software packages between the second version to a third version of the software program. The package difference may be a change to package associated with a software program, and the third version of the software program may be newer then second version of the software program. The analyzer may then output, before the computing device is upgraded from the first version to the second version, a notification indicating the package difference to the user. With the notification output to the user, the user will be able to make a more informed decision regarding which version of the software program to upgrade to, whether to upgrade at all, or which packages to use in a software program. For instance, notification may indicate the second version of the software program introduces a software package later removed in the third version. The user may then choose to upgrade to the third version or avoid using the software package from the second version.

In some examples, the analyzer may also determine that the change to the package is incompatible with a hardware component of the computing device and generate an output to a user indicating the incompatibility. The analyzer may also identify a vulnerability in the third version of the software program resulting from the package difference. The vulnerability may be absent from the second version of the software program but present in the third version of the software program. The analyzer may then generate an output to a user indicating the vulnerability. The incompatibility and vulnerability outputs may similarly assist the user in making a more informed decision regarding which version of the software program to upgrade to, whether to upgrade at all, or which packages to use in a software program. For instance, an incompatibility output may indicate to a user that in a third version of the software program, a program package requires a hardware component not found in the user's hardware system. The user may then mitigate risk by choosing to avoid upgrading to the third version. Similarly, the vulnerability output may indicate to the user that a software package in the second version includes a vulnerability, but the vulnerability is not present in the third version. The user may then mitigate risk by choosing to upgrade to the third version of the software program.

These illustrative examples are given to introduce the reader to the general subject matter discussed here and are not intended to limit the scope of the disclosed concepts. The following sections describe various additional features and examples with reference to the drawings in which like numerals indicate like elements but, like the illustrative examples, should not be used to limit the present disclosure.

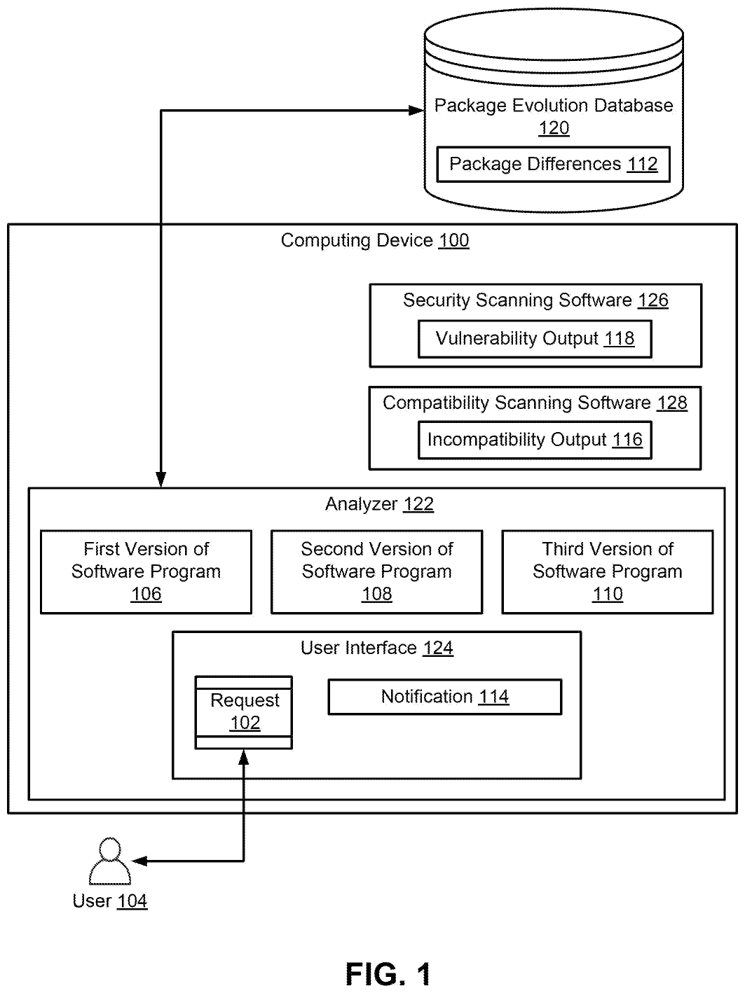

Turning now to FIG. 1, FIG. 1 shows a block diagram of an example of a system for automatically determining and outputting package differences between software program versions according to some aspects of the present disclosure. The system includes a computing device 100 with an analyzer 122. Examples of the computing device 100 can include a laptop computer, desktop computer, server, mobile phone, or tablet. The computing device 100 can be communicatively coupled to a package evolution database 120.

The analyzer 122 can be configured to provide a user interface 124 to a user 104. The analyzer 122 may receive a request 102 from a user 104, via the user interface 124, to upgrade a software program from a current version to a newer version. The software program may be an operating system, an application (“app”), utility software, or some other form of software including packages that may vary from version to a newer version. The first and second software program versions may be consecutive, where the first version is immediately followed by the second version, or may be non-consecutive, where the first version is followed by intermediate versions, before the second version.

In response to receiving the request 102, the analyzer 122 may then transmit a query to the package evolution database 120. The query can be for retrieving information about the packages in the first version 106 of the software program, the second version 108 of the software program, and/or a third version 110 of the software program. The third version 110 of the software program can be newer than the second version 108 of the software program.

The package evolution database 120 may be a data structure that stores metadata related to the packages, including package differences 112 between the different versions of the software program. The package differences 112 may include changes to packages, such as that a package was renamed, split, merged, deleted, renamed, replaced, or otherwise changed between versions of software programs. The package evolution database 120 may thus indicate changes to packages between two or more versions of the software program. The package evolution database 120 may include a list of multiple packages for which there are differences between different versions of the software program, such as between the first version 106, second version 108, and the third version 110 of the software program. The packages themselves may be include software libraries, applications, utilities, executables, or other software components that change between software program versions.

The package differences 112 may relate to differences between any combination of first version 106, second version 108, and third version 110 of the software program. For instance, the package differences 112 may be between the first version 106 and second version 108, the second version 108 and third version 110, the first version 106 and third version 110, or any other comparison between an earlier version and subsequent one or more versions.

After receiving the information about the package differences 112 from the package evolution database 120, the analyzer 122 can perform analysis operations to provide a notification 114 to the user 104 through a user interface 124. For instance, the analyzer 122 may determine a package difference 112 between the second version 108 and the third version 110 of the software program, where the package difference 112 is a change to a package associated with the software program. The analyzer 122 may determine package differences between an earlier version and any subsequent version, or multiple subsequent versions of the software program.

Once the analysis is performed by the analyzer 122, the analyzer 122 may output, prior to the computing device being upgraded from the first version 106 to the second version 108 of the software program, a notification 114 indicating that the package difference 112 to the user 104. The notification 114 may indicate to the user 104 that one or more packages would be altered between the first and second versions of the software program. Additionally, or alternatively, the notification 114 may indicate that one or more packages may be altered between the second version 108 and the third version 110. Even though the user 104 is not currently attempting to upgrade to the third version 110, this may still be helpful information for the user 104 and may inform their upgrade decision. In some examples, the notification 114 may indicate that no changes to any of the packages would occur between upgrading from the first version 106 to any subsequent version of the software program.

With the generated notification 114 sent to the user 104, the user 104 will be able to make a more informed decision regarding which version 108, 110 of the software program to upgrade to, or whether to upgrade at all. The notification 114 also allows the user 104 to determine which packages may be altered by future versions of the associated software program, which may inform how they use those packages in their own software development or computing configurations. For instance, the notification 114 may indicate to the user 104 that a package that is present in the second version 108 is subsequently deprecated or removed in the third version 110. As a result, the user 104 may choose not to use that package for a certain purpose, even though they may only be currently upgrading from the first version 106 to the second version 108.

The computing device 100 may also include security scanning software 126 and a compatibility scanning software 128 for use with the analyzer 122. The security scanning software 126 can be called by the analyzer 122 to identify a vulnerability associated with a package difference 112. For example, the analyzer 122 can provide information about the package difference 112 to the security scanning software 126, which can identify a vulnerability associated with the package difference 112. Upon identifying the vulnerability, the security scanning software 126 may generate a vulnerability output 118 indicating the vulnerability. The vulnerability output 118 may be displayed as part of the notification 114 in the user interface 124. This may help the user 104 understand the potential security impact associated with the upgrade so that they can make a more informed decision and potentially mitigate the impact. The security scanning software 126 may include antivirus or antimalware software, such as an off-the-shelf antivirus software or purpose-built antivirus software. The security scanning software 126 may automatically perform scanning operations on scheduled intervals, for example to identify packages with vulnerabilities and store vulnerabilities data in the package evolution database 120.

Similarly, the compatibility scanning software 128 can be called by the analyzer 122. For example, the analyzer 122 can provide information about the package difference 112 to the compatibility scanning software 128, which can determine that a change of a package is incompatible with a hardware component of the computing device 100. Upon determining that the change is incompatible, the compatibility scanning software 128 may generate an incompatibility output 116 indicating the incompatibility. The incompatibility may be displayed as part of the notification 114 in the user interface 124. This may help the user 104 understand the potential compatibility problem associated with the upgrade so that they can make a more informed decision and potentially mitigate the impact. Like the security scanning software 126, the compatibility scanning software 128 may automatically perform compatibility scanning operations on scheduled intervals, for example to detect hardware incompatibilities and store incompatibility data in the package evolution database 120.

In some embodiments, the package evolution database 120 may store vulnerability data identified by the security scanning software 126 and incompatibility data identified by the compatibility scanning software 128. In some such examples, the security scanning software 126 and compatibility scanning software 128 may be located off the computing device 100 and perform their functions externally to the computing device 100 to update the package evolution database 1290 with the relevant information. This may make it faster for the analyzer 122 to obtain such information—e.g., the analyzer 122 can request and receive such information from the package evolution database 120, without the computing device 100 having to execute the security scanning software 126 and/or the compatibility scanning software 128, which can conserve computing resources.

In some examples, the notification 114 can include a combination of one or more outputs from each of the analyzer 122, the security scanning software 126, and the compatibility scanning software 128. For instance, the third version 110 of a software program may include both vulnerabilities not present in earlier version of the software program and packages incompatible with the computing device 100 hardware. Upon a request 102 from a user 104 to upgrade from the first version 106 of the software program to the second version 108 of the software program, user interface 124 may provide a notification 114 to the user 104 indicating that while there are no vulnerabilities in the second version 108, future upgrades to the third version 110 include a software vulnerability and are incompatible with the current hardware of the computing device 100.

Although the analyzer 122, the security scanning software 126, and the compatibility scanning software 128 are shown on the computing device 100, in other examples some or all of those components may be located elsewhere. For instance, the analyzer 122, the security scanning software 126, and/or the compatibility scanning software 128 may be positioned on a server system that is remote from the computing device 100. The user 104 can operate the computing device 100 to transmit the request 102 to the server system, for example over one or more networks such as the Internet. The request 102 may include information about the computing device 100, such as its current hardware components. In response to receiving the request 102, the server system can execute the analyzer 122, the security scanning software 126, and/or the compatibility scanning software 128. The server system may be coupled to the package evolution database 120 for use in performing the analysis. The server system may then provide the notification 114 back to the computing device 100 for display to the user 104. Thus, the analysis may take place in a location other than the computing device 100 that will undergo the upgrade.

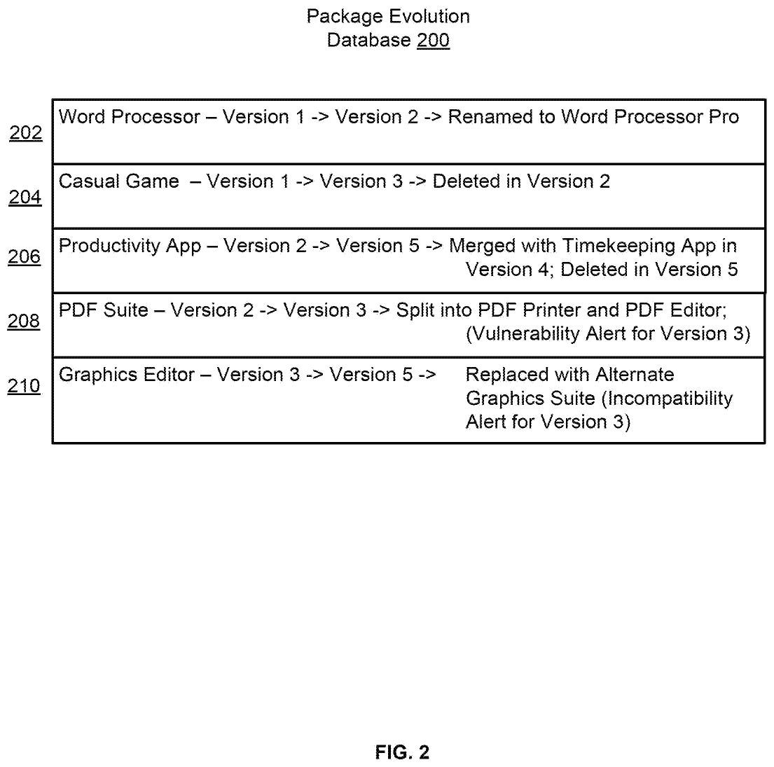

Turning now to FIG. 2, FIG. 2 is a block diagram of an example of a package evolution database 200 according to some aspects of the present disclosure. The package evolution database 200 includes five examples of package changes between versions of a software program. The package differences 112 shown provide examples of data that may be retrieved by the analyzer 122 of FIG. 1. The examples 202-210 are not intended to be exhaustive and are instead intended to provide examples of the types of package differences that may be stored in the package evolution database 200. The package evolution database 200 may be maintained (e.g., updated) by a developer or other entity associated with the software program.

The first package change 202 shown relates to a word processor software package. The package change 202 indicates that between a first version of a software program and a second version of the software program, the word processor package was renamed to word processor pro.

The second package change 204 relates to a casual game package. The package change 204 indicates that from the first version of the software program to a third version of the software program, the casual game package was deleted. The package change 204 may further indicate the specific version of the software program where the package was deleted. The package change 204 indicates that the casual games package was deleted in version 3.

The third package change 206 relates to a productivity app package. The package change 206 indicates that between the second version of the software program and a fifth version of the software program, the productivity app was merged with a timekeeping app in version 4, and then deleted in version 5.

The fourth package change 208 relates to a PDF suite package. The package change 208 indicates that between the second version of the software program and the third version of the software program, the PDF suite was split into a PDF printer app and a PDF editor app. The package change may include a vulnerability alert that indicates that a package has a known vulnerability. In the case of package change 208, the package change 208 indicates that the PDF suite has a known vulnerability at the third version when the PDF suit splits into the PDF Printer and the PDF editor.

The fifth package change 210 relates to a graphics editor package. The package change 210 indicates that between versions three and five of the software program, the graphics editor was replaced with an alternative graphics suite. The package change may include an incompatibility alert that indicates that a package is incompatible with a particular computing device. In the case of the package change 210, the package change 210 indicates that the Alternate Graphics suite replacement is incompatible with the current computing device.

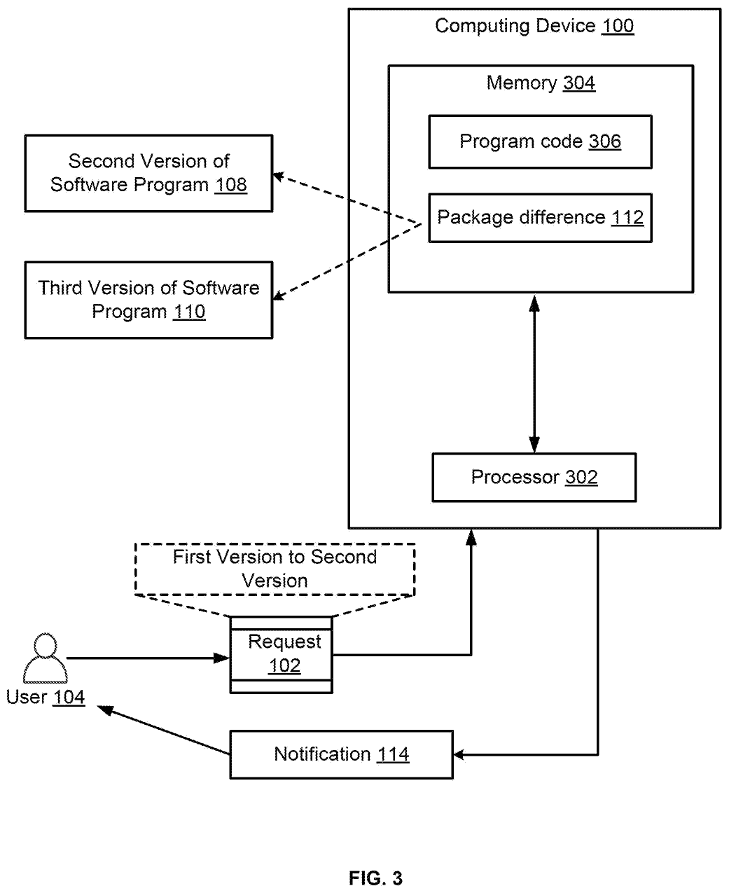

Turning now to FIG. 3, FIG. 3 shows a block diagram of an example of a system for determining and notifying users of package differences between versions of a software program according to some aspects of the present disclosure. The example system of FIG. 3 includes a processor 302, a memory 304, and program code 306 that is executable by the processor 302.

The processor 302 can include one processor or multiple processors. Non-limiting examples of the processor 302 include a Field-Programmable Gate Array (FPGA), an application-specific integrated circuit (ASIC), a microprocessor, or a combination thereof. The processor 302 can execute program code 306 stored in the memory 304 to perform operations. In some examples, the program code 306 can include processor-specific instructions generated by a compiler or an interpreter from code written in any suitable computer-programming language, such as C, C++, C#, and Java.

The memory 304 can include one memory or multiple memories. Memory 304 can be volatile or non-volatile (e.g., any type of memory device that retains stored information when powered off). Non-limiting examples of memory 304 include electrically erasable and programmable read-only memory (EEPROM), flash memory, or any other type of non-volatile memory. At least some of the memory 304 includes a non-transitory computer-readable medium from which the processor 302 can read program code 306. A computer-readable medium can include electronic, optical, magnetic, or other storage devices capable of providing the one or more processors 302 with computer-readable program code 306 or other instructions. Examples of a computer-readable medium can include magnetic disks, memory chips, ROM, random-access memory RAM, an ASIC, a configured processor, optical storage, or any other medium from which a computer processor can read program code or instructions.

In some examples, the processor 302 can execute the program code 306 to perform any of the operations described herein. For example, the processor 302 may receive a request 102 from a user 104. In the example of FIG. 3, the request 102 is associated with upgrading a software program of a computing device, which may or may not be the computing device 100, from a first version to a second version, where the second version is newer than the first version. In response to receiving the request 102, the processor 302 may determine a package difference 112 between the second version 108 and a third version 110 of the software program. The third version 110 of the software program may be newer than the second version 108 of the software program. The package difference 112 may be a change to a package associated with the software program. The processor 302 may then output a notification 114 indicating the package difference 112 to the user 104. The processor 302 may output the notification 114 prior to the computing device being upgraded from the first version to the second version 108 of the software program, per the user 104 request 102.

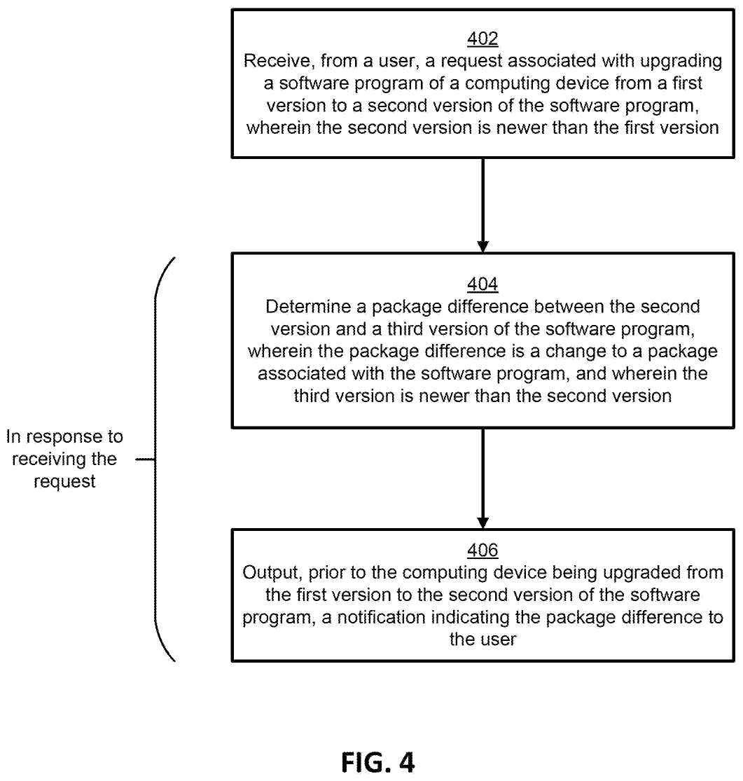

Turning now to FIG. 4, FIG. 4 shows a flowchart of an example of a process for automatically detecting package differences according to some aspects of the present disclosure. Other examples may include more operations, fewer operations, different operations, or a different order of the operations shown in FIG. 4. The operations of FIG. 4 will now be described below with reference to the components of FIGS. 1 and 3.

In block 402, the processor 302 receives a request 102 from a user 104. The request 102 may be associated with upgrading a software program of a computing device 100 from a first version 106 to a second version 108 of the software program. In the example of FIG. 4, the second version 108 of the software program is newer than the first version 106.

In block 404, the processor 302, in response to receiving the request 102, determines a package difference 112 between the second version 108 and a third version 110 of the software program. In the example of FIG. 4, the third version 110 of the software program is newer than the second version 108. The package difference 112 can be a change to a package associated with the software program. The processor 302 can determine multiple package differences between the software program versions. For example, the processor 302 may check all changes between the target version, and the successive version following the target version requested by the user 104.

In block 406, the processor outputs a notification 114 indicating the package difference 112 to the user 104. The notification 114 can be output by the processor 302 prior to the computing device 100 being upgraded from the first version of the software program to the second version. For instance, the notification 114 may indicate to the user 104 that after the second version, the package is deprecated since it will be removed in the third version.

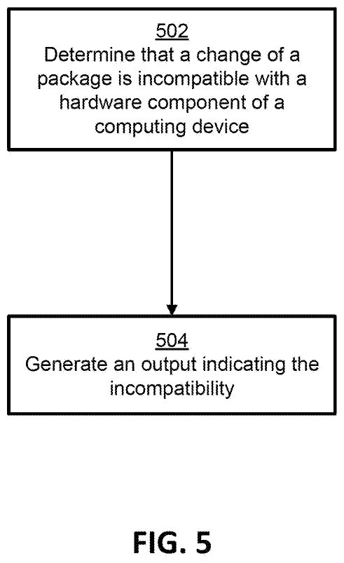

Turning now to FIG. 5, FIG. 5 shows a flowchart of an example of a process for determining an incompatibility and generating an output indicating the incompatibility according to some aspects of the present disclosure. Other examples may include more operations, fewer operations, different operations, or a different order of the operations shown in FIG. 5. The operations of FIG. 5 will now be described below with reference to the components of FIGS. 1 and 3.

In block 502, the compatibility scanning software 128 determines that a change of a package is incompatible with a hardware component of a computing device 100. For example, the system can provide the compatibility scanning software 128 with details about the hardware of the computing device 100, or the compatibility scanning software 128 can automatically scan the computer system to detect the connected hardware, so that the compatibility scanning software 128 can determine which hardware is present in the computing device 100. The compatibility scanning software 128 may then rely on embedded logic and/or the package evolution database 120 to determine any compatibility problems associated with a package change. For instance, the compatibility scanning software 128 can determine that a package in a second version of a software program may require a particular graphics card that may not be present on the computing device 100.

In block 504, the compatibility scanning software 128 generates an output indicating the incompatibility output 116. The incompatibility output 116 may be generated for display in the user interface 124, for instance, through a notification 114. As an example, the incompatibility output 116 may indicate to the user 104 that upgrading from a first version 106 of a software program to a second version 108 or a third version 110 may produce an incompatibility with the current hardware of the computing device 100. The user 104 may then have the option to decline the software program upgrade.

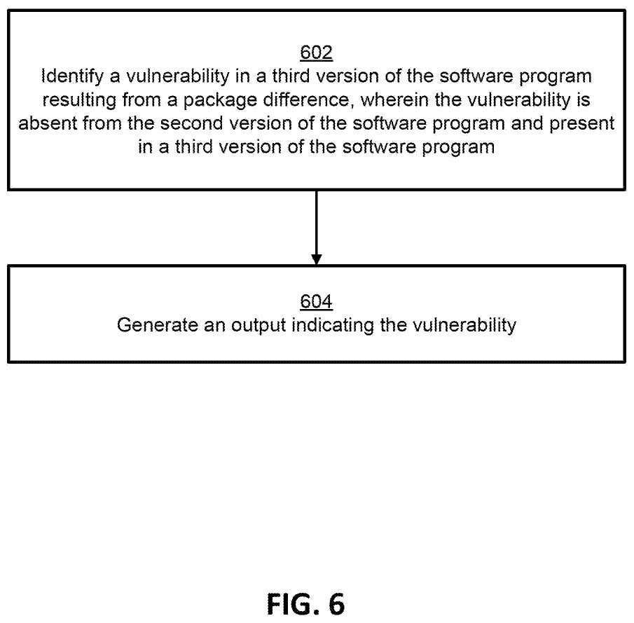

Turning now to FIG. 6, FIG. 6 shows a flowchart of an example of a process for identifying a vulnerability and generating an output indicating the vulnerability according to some aspects of the present disclosure. Other examples may include more operations, fewer operations, different operations, or a different order of the operations shown in FIG. 5. The operations of FIG. 6 will now be described below with reference to the components of FIGS. 1 and 3.

In block 602, the security scanning software 126 identifies a vulnerability in a third version 110 of the software program resulting from a package difference 112, where the vulnerability is absent from the second version 108 of the software program. Block 602 may occur after the processor 302 receives a request 102 associated with upgrading a software program from a first version 106 to the second version 108. The identified vulnerability may include a known weakness to a specific package or software program as stored in the package evolution database 120.

In block 604, the security scanning software 126 generates a vulnerability output 118 indicating the vulnerability. The vulnerability output 118 may be generated for display in the user interface 124, for instance, through a notification 114. The security scanning software 126 can thus provide a vulnerability output 118 that indicates to the user 104 that while a specific requested upgrade from a first version 106 to a second version 108 of a software program does not provide vulnerability, that a future upgrade to the software program may include the vulnerability.

The foregoing description of certain examples, including illustrated examples, has been presented only for the purpose of illustration and description and is not intended to be exhaustive or to limit the disclosure to the precise forms disclosed. Numerous modifications, adaptations, and uses thereof will be apparent to those skilled in the art without departing from the scope of the disclosure. For instance, any examples described herein can be combined with any other examples to yield further examples.

1. A method comprising:
receiving, by one or more processors and from a user, a request associated with upgrading a software program of a computing device from a first version to a second version of the software program, wherein the second version is newer than the first version; and
in response to receiving the request:
determining, by the one or more processors, a package difference between the second version and a third version of the software program, wherein the package difference is a change to a package associated with the software program, and wherein the third version is newer than the second version; and
outputting, by the one or more processors, and prior to the computing device being upgraded from the first version to the second version of the software program, a notification indicating the package difference.

2. The method of claim 1, wherein the package difference includes a list of multiple packages for which there are differences between the second version and the third version of the software program.

3. The method of claim 1, wherein the software program is an operating system.

4. The method of claim 1, wherein the package is a software library.

5. The method of claim 1, wherein determining the package difference involves accessing a package evolution database, wherein the package evolution database indicates changes to packages between two or more versions of the software program.

6. The method of claim 5, wherein the package evolution database includes an entry indicating the change to the package.

7. The method of claim 1, further comprising:
determining that the change to the package is incompatible with a hardware component of the computing device; and
generating an output indicating the incompatibility.

8. The method of claim 1, further comprising:
identifying a vulnerability in the second version of the software program resulting from the package difference, wherein the vulnerability is absent from the second version of the software program and present in the third version of the software program; and
generating an output indicating the vulnerability.

9. A non-transitory computer-readable medium comprising program code that is executable by one or more processors for causing the one or more processors to perform operations including:
receiving, from a user, a request associated with upgrading a software program of a computing device from a first version to a second version of the software program, wherein the second version is newer than the first version; and
in response to receiving the request:
determining a package difference between the second version and a third version of the software program, wherein the package difference is a change to a package associated with the software program, and wherein the third version is newer than the second version; and
outputting, prior to the computing device being upgraded from the first version to the second version of the software program, a notification indicating the package difference.

10. The non-transitory computer-readable medium of claim 9, wherein the package difference includes a list of multiple packages for which there are differences between the second version and the third version of the software program.

11. The non-transitory computer-readable medium of claim 9, wherein the software program is an operating system.

12. The non-transitory computer-readable medium of claim 9, wherein the package is a software library.

13. The non-transitory computer-readable medium of claim 9, wherein determining the package difference involves accessing a package evolution database, wherein the package evolution database indicates changes to packages between two or more versions of the software program.

14. The non-transitory computer-readable medium of claim 13, wherein the package evolution database includes an entry indicating the change to the package.

15. The non-transitory computer-readable medium of claim 9, wherein the operations further comprise:
determining that the change to the package is incompatible with a hardware component of the computing device; and
generating an output indicating the incompatibility.

16. The non-transitory computer-readable medium of claim 9, wherein the operations further comprise:
identifying a vulnerability in the second version of the software program resulting from the package difference, wherein the vulnerability is absent from the second version of the software program and present in the third version of the software program; and
generating an output indicating the vulnerability.

17. A system comprising:
one or more processors; and
one or more memories including program code that is executable by the one or more processors for causing the one or more processors to perform operations including:
receiving, from a user, a request associated with upgrading a software program of a computing device from a first version to a second version of the software program, wherein the second version is newer than the first version; and
in response to receiving the request:
determining a package difference between the second version and a third version of the software program, wherein the package difference is a change to a package associated with the software program, and wherein the third version is newer than the second version; and
outputting, prior to the computing device being upgraded from the first version to the second version of the software program, a notification indicating the package difference to the user.

18. The system of claim 17, wherein the package difference includes a list of multiple packages for which there are differences between the second version and the third version of the software program.

19. The system of claim 17, wherein determining the package difference involves accessing a package evolution database, wherein the package evolution database indicates changes to packages between two or more versions of the software program, and wherein the package evolution database includes an entry indicating the change to the package.

20. The system of claim 17, wherein the package difference includes a name change to the package, a merger of the package with another package, a deletion of the package, a replacement of the package with another package, or a split of a portion of the package into a separate package.
